(19) United States
(12) Patent Application Publication
(10) Pub. No.: US 2008/0104543 A1
(43) Pub. Date: May 1, 2008

(54) Guidance Apparatus, Method and Program of Analysis Work

(76) Inventors: Takashi Yokohari, Bando (JP); Ichiro Nishigaki, Ishioka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/876,800

(22) Filed: Oct. 23, 2007

(30) Foreign Application Priority Data
Oct. 25, 2006 (JP) 2006-290380

(51) Int. Cl. G06F 3/048; G06F 19/00

(52) U.S. Cl. 715/810; 703/13

(57) ABSTRACT

An analysis purpose input means, an analysis process generation means, an analysis process display means, an analysis process execution means and an analysis process storage means are provided. Modeling techniques conforming to the analysis purpose, analysis techniques, analysis result evaluation techniques, information on computation period, cost and computer kind as limiting conditions associated with these techniques, and information on automation rate are stored in the form of an analysis information network in the analysis process database. Then, a plurality of analysis processes conforming to the purpose are determined and the period and cost for each analysis process are evaluated. An optimal analysis process conforming to the limiting conditions entered is displayed to guide the analysis work.

### BACKGROUND OF THE INVENTION

The present invention relates to an analysis work guidance apparatus and method to support rationalizing, and enhancing an efficiency of, design and analysis work by using computers, databases and various software programs. It also relates to a program to implement the method.

A technique of guiding a design work according to a procedure described in a design template that defines the content and procedure of an analysis work to be performed by CAE (Computer Aided Engineering) in the design work is disclosed in JP-A-2001-290846. In the design template shown on an operation screen of a display, icons representing content of each work process are arranged in the order of execution, and a designer performs the design work by picking the icons in the order of process execution. For each work process, software tools, data to be referenced, a format of data to be prepared and others that are required for this work are predefined, and the designer can use the defined software tools and associated data by picking the icon corresponding to the work process.

JP-A-2005-301336 discloses a design support system that accumulates in a reusable form knowledge and design procedure of senior designers regarding the design and development of products and molds and which reconfigures a design flow in a short period of time and issues one instruction after another to a beginner with little design experience in ways that they can understand. The designer performs the design work according to the work instructions shown on an instruction screen of the design support system. The instruction screen displays a design work flow screen and a work step flow chart, both automatically generated, that allow the designer to grasp the situation he or she is currently in as he proceeds.

Conventional work guidance apparatus are designed to follow a work process specified in advance by other person (expert) and thus do not provide an optimal procedure according to a purpose of analysis and limiting conditions although they can provide design information and design tools in connection with a standard work procedure and work content. Since these conventional apparatus perform simulations in place of experiments and analyzes observed phenomena by using CAE, they may fall into a trial and error situation in which they do not know where to start from and how to evaluate and thus are unable to execute analysis in an appropriate process. An object of this invention is to provide users with an appropriate analyzing process.

With a view to overcoming the above problem, the present invention has been accomplished to provide users with an appropriate analyzing process.

### SUMMARY OF THE INVENTION

This invention comprises an analysis purpose input means, an analysis process generation means, an analysis process display means, an analysis process execution means and an analysis process storage means. Modeling techniques conforming to a purpose of analysis or what the user wishes to do, analysis techniques, analysis result evaluation techniques, information on computation period, cost and computer kind as limiting conditions associated with these techniques, and information on automation rate are stored as an “analysis information network” in an analysis process database. The “analysis information network” includes past analysis results, hardware/software infrastructure environments, and information on computation time and cost under these environments. Then, (1) a plurality of analysis processes conforming to the purpose are determined; (2) the periods and costs for the analysis processes are evaluated; and (3) analysis process candidates conforming to the limiting conditions entered are arranged in order of priority and displayed.

There are cases where, even if various tools are prepared, the user may not know which tools should be used in what way. In such a circumstance, this invention can recommend an optimal analysis process to the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing a work support apparatus according to one embodiment of this invention.

FIG. 2 is a flow chart showing an example of processing performed by an analysis process generation unit according to one embodiment.

FIG. 3 is an explanatory diagram showing an example of data in an analysis information network according to one embodiment.

FIG. 4 is an explanatory diagram of a tree structure in the analysis information network according to one embodiment, showing computers to be used for different computation scales.

FIG. 5 is a table showing an example of property for each node in the analysis information network according to one embodiment.

FIG. 6 is an explanatory diagram showing an example of operation screen in an analysis purpose input unit according to one embodiment.

FIG. 7 is an explanatory diagram showing an example of display screen of an analysis process according to one embodiment.

FIG. 8 is an explanatory diagram showing an example of subprocesses defined in each analysis work according to one embodiment.

FIG. 9 is an explanatory diagram showing an example screen for guiding an analysis work according to one embodiment.

### DETAILED DESCRIPTION OF THE INVENTION

One embodiment of this invention will be described by referring to the accompanying drawings.

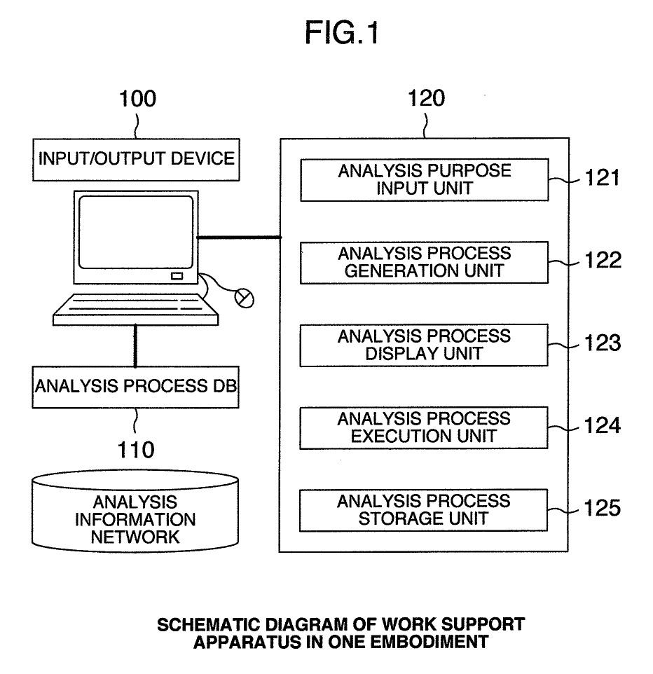

FIG. 1 shows one embodiment of the work support apparatus according to the present invention. Reference number 100 represents a computer for data input/output and calculation. Denoted 110 is an analysis process database to store analysis processes in a configuration of an analysis information network. Denoted 120 is an arithmetic operation unit which has the following components.

Denoted 121 is an analysis purpose input unit to enter what the user wishes to analyze and limiting conditions for the analysis.

Denoted 122 is an analysis process generation unit to derive an analysis process, that best matches the analysis purpose, from an analysis means having a plurality of branched processes, based on a modeling technique, an analysis technique, an analysis result evaluation technique and also information, associated with these techniques, on a period of time and cost taken by computation and on the kind of computer, all these conforming to the purpose of analysis and stored in the analysis process database.

Denoted 123 is an analysis process display unit that displays a plurality of analysis process candidates generated by the analysis process generation unit for the user to select.

Denoted 124 is an analysis process execution unit to guide the analysis work by the selected analysis process.

Denoted 125 is an analysis process storage unit to input and accumulate an analysis history or information on analysis.

An overall flow of processing in this embodiment is the same as the order of arrangement of the constitutional elements in the arithmetic operation unit 120 of FIG. 1. More specifically, when the user enters the analysis purpose through the analysis purpose input unit 121, the analysis process generation unit 122 generates an appropriate analysis process, according to which the user performs operation.

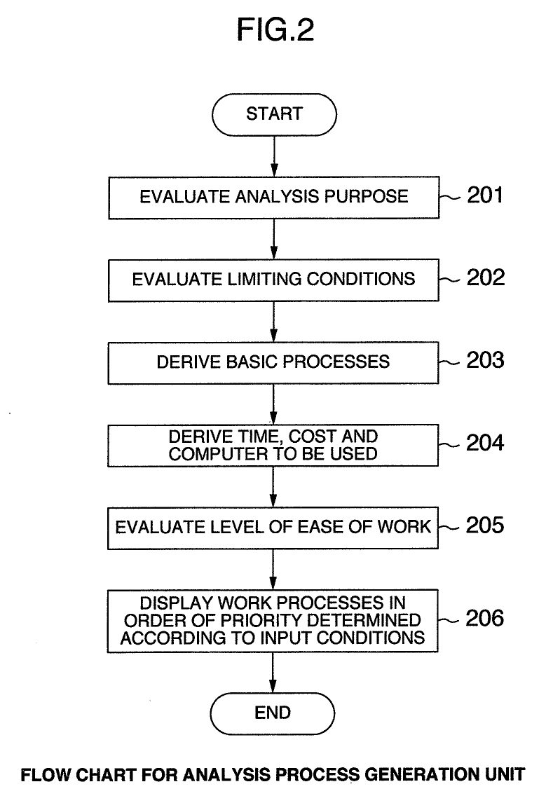

FIG. 2 is a flow chart showing an example process executed by the analysis process generation unit 122 in the arithmetic operation unit 120 of FIG. 1. The procedure involves first deriving a plurality of analysis processes conforming to the purpose entered, evaluating their period and cost, giving higher priorities to those candidates conforming to the limiting conditions entered, and then displaying them. That is, the procedure executes in this order a step of evaluating analysis purpose (step 201), a step of evaluating the limiting conditions (step 202), a step of deriving basic processes (step 203), a step of deriving their time, cost and computer to be used (step 204), a step of evaluating a level of ease of the work (step 205), and a step of arranging the derived work processes in a priority order determined by the input conditions and displaying them (step 206).

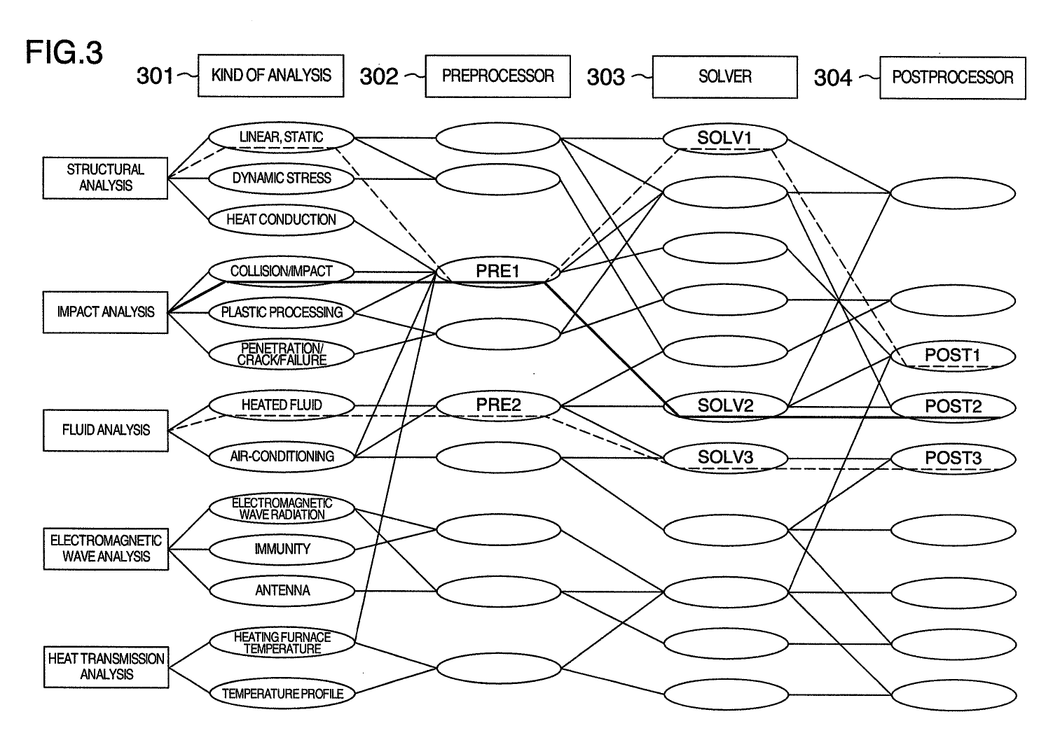

FIG. 3 shows an example data of analysis information network stored in the analysis process database 110 of FIG. 1. The analysis process database 110 stores preprocessors 302 (modeling techniques) corresponding to various past analysis kinds 301, solvers 303 (analysis techniques) and postprocessors 304 (analysis result evaluation methods) as a series of analysis processes. The analysis kinds 301, preprocessors 302, solvers 303 and postprocessors 304 each store a plurality of pieces of data. In the example of FIG. 3, as rough analysis kinds 301, there are prepared a structural analysis, impact analysis, fluid analysis, electromagnetic wave analysis and heat transmission analysis. The structural analysis includes a linear static analysis, dynamic stress analysis and heat conduction analysis. The impact analysis includes a collision/impact analysis, a plastic processing analysis, and a penetration/fracture/failure analysis. As the fluid analysis, there are provided a heated fluid analysis and an air-conditioning analysis. As the electromagnetic wave analysis, there are provided a radio wave radiation analysis, an immunity analysis and an antenna analysis. The heat transmission analysis includes a heating furnace temperature analysis and a temperature profile analysis. As for details, a variety of analyses may be contemplated according to the kind of analysis.

Further, the limiting conditions, such as information on calculation time, calculation cost and computer kind and information on automation rate representing the level of ease of the analysis work, are added to each of the techniques described above, according to the current hardware/software infrastructure environment, to build an analysis information network. Routes shown in fine lines in FIG. 3 represent branch destinations that can be chosen in each step successively beginning with the analysis kinds 301.

In FIG. 3, routes shown in thick lines and dashed lines represent cases of past analyses. For example, these routes indicate analysis processes which, although they have different purposes, used the same preprocessor, then branched into different solvers and branched into postprocessors appropriate for evaluating their respective analysis results.

That is, in an analysis information network that has been built based on the past analysis processes and appropriate branch destinations that can be set as facts in advance, an optimal analysis process is determined according to the conditions entered by the user.

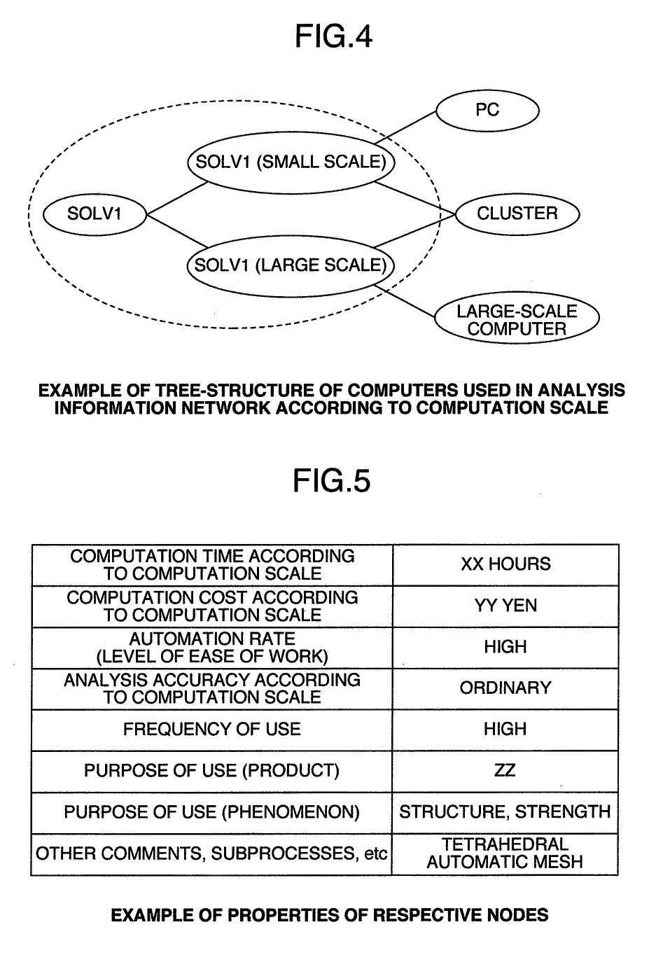

FIG. 4 shows a detail of the solver of FIG. 3. This example provides a small-scale computation SOLV1 and a large-scale computation SOLV1 as attributes of the solver SOLV1. For the small-scale computation SOLV1, branches are shown to use a PC (personal computer) or a cluster computer. For the large-scale computation SOLV1, branches are shown to use a cluster computer or large-scale computer. In this way, the computer to be used is guided to an appropriate one according to the scale of computation.

FIG. 5 shows one example of properties of nodes in the analysis information network. In this example, the computation time according to the computation scale, the computation cost according to the computation scale, the automation rate representing the level of ease of the analysis work, the analysis accuracy according to the computation scale, the frequency of use of the technique of interest, and the purpose of the technique (product and phenomenon) are entered as indices for determining a preferential analysis process. Some of these pieces of information may be extracted automatically after the analysis process is completed. As to an item “other comment, subprocess, etc.” it will be described in the following explanation of the analysis process display and the analysis guidance.

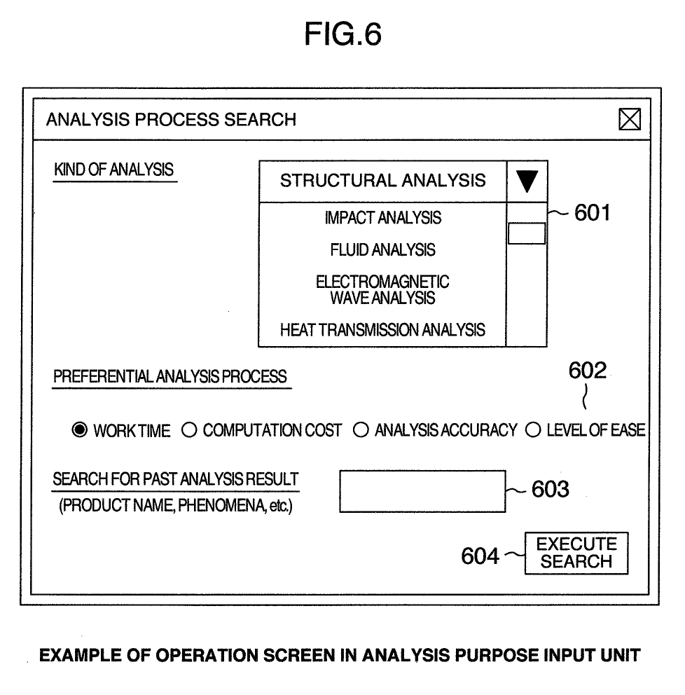

FIG. 6 shows an example of operation screen of the analysis purpose input unit 121, which comprises an analysis kind selection part 601, a preferential analysis process specifying part 602, a past analysis result searching part 603, and a search execution instruction part 604. The analysis kind includes, for example, a structural analysis, impact analysis, fluid analysis, electromagnetic wave analysis and heat transmission analysis. Information on a product and phenomenon to be analyzed is entered through this operation screen and checked against the analysis information network to determine basic analysis processes. Preferential analysis processes are specified with work time, computation cost, analysis accuracy and level of ease. This allows the user, for example, to give preference to the work time when an analysis is urgently required and, when the user is not familiar with the operation of tools in the analysis work, to give preference to the level of ease. After these selection and input have been made, the execution is instructed by the search execution instruction part 604. If the past analysis result searching part 603 is used, a product name and a phenomenon to be searched are entered and data matching the conditions are searched through the database and displayed.

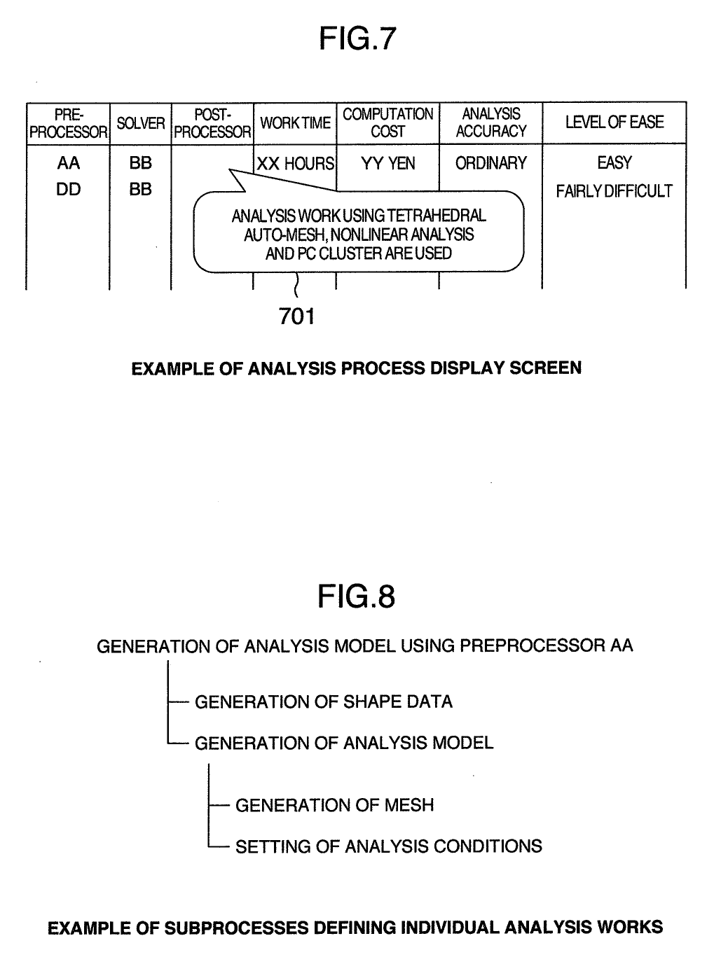

FIG. 7 shows an example of display screen of the analysis process. Regarding the basic analysis process information on which tools (preprocessor, solver and postprocessor) should be used according to the analysis purpose, a plurality of possible candidates are obtained from the analysis information network. Then, for each candidate, the work time, calculation cost, analysis accuracy and level of ease derived from the property information are displayed in the order of priority specified by the user. Further, by using information on the “other comment” item in the property table, a supplementary explanation 701 for the analysis process may be displayed on the screen, as shown in FIG. 7. Or, rather than displaying a list of candidates for analysis process shown in FIG. 7, it is possible to narrow down preferential analysis processes specified by the user on the display screen of FIG. 6 to one optimal candidate and then proceed to an analysis work guidance process, which is explained in the following.

FIG. 8 shows an example of subprocess defined in each analysis work. Here is shown a process of generating an analysis model using a preprocessor AA. This subprocess comprises a shape data generation, a mesh generation and an analysis condition setting and provides information that guides the analysis model generation work using the preprocessor AA. This subprocess is defined as a property of a node that requires a subprocess in the analysis information network.

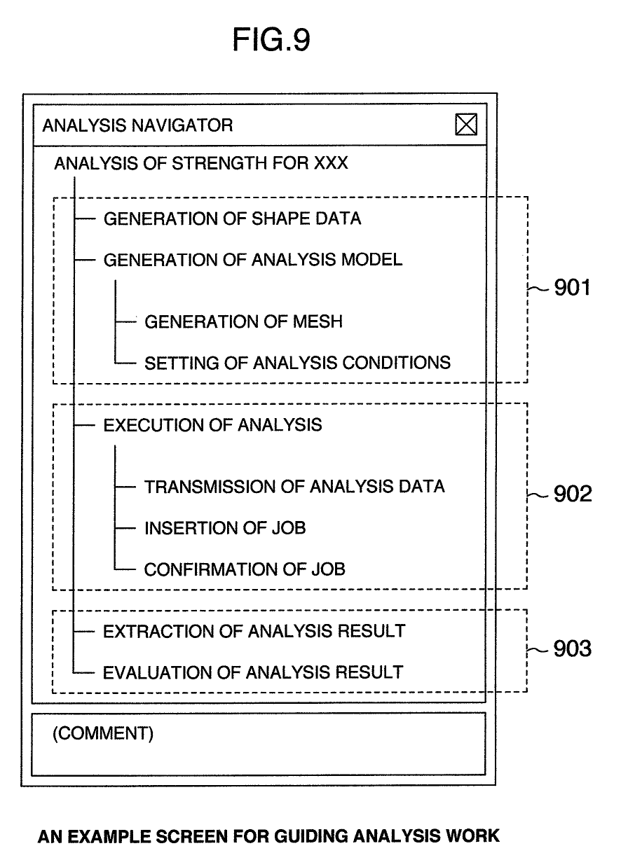

FIG. 9 shows an example screen that guides an analysis work according to an analysis process that has been generated. Reference numbers 901, 902 and 903 in FIG. 9 represent subprocesses to execute the preprocessor, solver and postprocessor selected by this process and are arranged and displayed in the order of execution to ensure continuous processing of the series of works. After this, as in the conventional art, icons are picked in the order shown on the navigator screen to proceed with the analysis work. In each step it is possible to define in advance software tools required by the work, data to be referenced and formats of data to be generated. In that case, the operator can use the software tools and related data defined in each step of work by picking the icon. As shown in FIG. 9, a comment column may be provided so that a comment, if any, can be displayed. The comment may be entered by the operator.

Although the process in this embodiment has been described to be executed by a work support apparatus such as shown in FIG. 1, the execution procedure may be programmed and the resultant program installed in a general-purpose computer which in turn executes the similar processing.

It should be further understood by those skilled in the art that although the foregoing description has been made on embodiments of the invention, the invention is not limited thereto and various changes and modifications may be made without departing from the spirit of the invention and the scope of the appended claims.

1. An analysis work guidance apparatus for guiding an analysis work, that uses computers, according to a template defining a procedure for the analysis work, the apparatus comprising:
an analysis process storage means;
an analysis purpose input means for inputting a purpose of analysis; and
an analysis process generation means for generating an analysis process conforming to the purpose of analysis entered by the analysis purpose input means, according to analysis processes stored in the analysis process storage means; and
an analysis process display means for displaying the analysis process generated by the analysis process generation means;
wherein the analysis process generation means derives an analysis process, that matches the analysis purpose, from among analysis techniques having a plurality of branched processes according to at least one of pieces of information on modeling techniques conforming to the analysis purpose, information on analysis techniques, information on analysis result evaluation techniques, and information on computation period, cost and computer kind, that are stored in the analysis process storage means;
wherein the analysis work is guided by the derived analysis process.

2. An analysis work guidance apparatus according to claim 1,
wherein the information stored in an analysis process database as the analysis process storage means includes information on a level of ease of individual works in the analysis process;
wherein the analysis process generation means evaluates, based on the level of ease of individual works, the level of ease of the analysis process derived according to the analysis purpose and limiting conditions and displays on the analysis process display means the analysis process and the level of ease of the analysis process.

3. An analysis work guidance apparatus according to claim 1, further including:
a display means for arranging a plurality of analysis processes conforming to the analysis purpose and limiting conditions entered in order of priority according to a result of evaluation in terms of the computation cost and the level of ease and for displaying a list of the preferentially arranged analysis processes; and
a means for selecting a desired analysis process from the list;
wherein the analysis work is guided by the selected analysis process.

4. An analysis work guidance apparatus according to claim 2, further including:
a display means for arranging a plurality of analysis processes conforming to the analysis purpose and limiting conditions entered, in order of priority according to a result of evaluation in terms of the computation cost and the level of ease and for displaying a list of the preferentially arranged analysis processes; and
a means for selecting a desired analysis process from the list;
wherein the analysis work is guided by the selected analysis process.

5. An analysis work guidance method for guiding an analysis work, that uses computers, according to a template defining a procedure for the analysis work, the method comprising:
an analysis process generation step to generate an analysis process conforming to a purpose of analysis according to analysis processes stored in an analysis process database; and
an analysis process display step to display the analysis process generated by the analysis process generation step;
wherein the analysis process generation step derives an analysis process, that matches the analysis purpose, from among analysis techniques having a plurality of branched processes according to at least one of pieces of information on modeling techniques conforming to the analysis purpose, information on analysis techniques, information on analysis result evaluation techniques, and information on computation period, cost and computer kind, that are stored in the analysis process database;
wherein the analysis work is guided by the derived analysis process.

6. A computer-readable storage medium storing a program executed by a computer for guiding an analysis work, that uses computers, according to a template defining a procedure for the analysis work, the program comprising:
an analysis process generation step to generate an analysis process conforming to a purpose of analysis according to analysis processes stored in an analysis process database; and
an analysis process display step to display the analysis process generated by the analysis process generation step on a display screen;
wherein the analysis process generation step derives an analysis process, that matches the analysis purpose, from among analysis techniques having a plurality of branched processes according to at least one of pieces of information on modeling techniques conforming to the analysis purpose that are stored in the analysis process database, information on analysis techniques, information on analysis result evaluation techniques, and information on computation period, cost and computer kind;
wherein the analysis work is guided by the derived analysis process.
